(19) United States
(12) Patent Application Publication
(10) Pub. No.: US 2014/0147061 A1
(43) Pub. Date: May 29, 2014

(54) SLIDING DOOR DRIVE

(71) Applicants: Lars Linnenkohl, Staufenberg (DE); Andreas Pellegrini, Edermunde (DE)

(72) Inventors: Lars Linnenkohl, Staufenberg (DE); Andreas Pellegrini, Edermunde (DE)

(73) Assignee: GEBR. BODE GMBH & CO. KG, Kassel (DE)

(21) Appl. No.: 13/825,195

(22) PCT Filed: Aug. 5, 2011
(86) PCT No.: PCT/EP2011/063534

§ 371 Date: May 29, 2013

(30) Foreign Application Priority Data
Sep. 21, 2010 (DE) 10 2010 041 160.4

(51) Int. Cl. F16C 31/02; F16C 35/10

(52) U.S. Cl. CPC F16C 31/02; F16C 35/10
USPC 384/26

(57) ABSTRACT

The invention relates to a sliding door drive (20). The sliding door drive (20) has: a drivable spindle (24) having a Z longitudinal axis, a spindle nut (20) which is movable on the spindle (24) along the Z longitudinal axis, an inner ring element (30) which surrounds the spindle nut (22) and is connected to the spindle nut (22) via two mutually diametrically opposite first shaft butts (28), which form a Y axis, in such a manner that the inner ring element (30) is pivotable about the Y axis and is displaceable along the Y axis, and an outer fork element (34) which is connected to the inner ring element (30) via two mutually diametrically opposite second shaft butts (32), which form a X axis, in such a manner that the outer fork element (34) is pivotable about the X axis and is displaceable along the X axis, wherein the outer fork element (34) has a support arm (26) for connection to the sliding door.

### FIELD

The disclosure relates to a sliding door drive for a displaceable sliding door wing of an intercity railway transportation vehicle.

### BACKGROUND

As defined herein, the term sliding door also refers to sliding doors or sliding door wings which, along with being linearly displaceable, can also execute a swivelling motion, so-called folding sliding doors.

Various structural designs are known for sliding doors, in which in particular the movement drive is connected in different ways with a displaceable sliding door wing. The sliding door wing is here most often mounted on a fixed guide rail in a longitudinally displaceable manner, if necessary rotatably arranged on a carriage that supports the sliding door wing. The carriage can here be swivelled around the guide rail, and the sliding door wing is also able to execute movements parallel to the axis of the guide rail. A rotatable drive spindle immovably fixed in place in the carriage body and a spindle nut running on the spindle are used for driving purposes. The connection between the spindle nut and carriage is established by means of a connecting rod, which can be swivelled both on the spindle nut and on the carriage around a respective axis parallel to the axis of the guide rail.

One significant disadvantage to this structural design is that the movement of the sliding door wing exposes the connecting rod to bending and shearing forces. These forces act on the two swivel joints, which is why they must exhibit a correspondingly resistant construction. The relatively large distance between the drive and carriage exposes both the carriage that supports the sliding door wing as well as the spindle nut to a tilting load on their seats during operation, which in particular in the carriage leads to an elevated edge loading, and in the spindle nut to a unilateral load on the thread.

Loads on the components also result from the balancing of tolerances, varying thermal expansions and signs of wear and tear during operation. A tilting of components becomes especially problematical in cases where the spindle nut is driven by manually displacing the sliding door wing during the reverse operation of the spindle nut. This case nearly precludes a parallel displacement of the carriage and spindle nut.

### SUMMARY

Disclosed is a drive for a sliding door or sliding door wing intended for permanent reliability in spite of the aforementioned difficulties. In particular, the sliding door drive is to enable a reverse operation by hand. The construction is here to be compact and space-saving, with a cost-effective manufacturing process.

According to the disclosure, the reliability is achieved by a sliding door drive for a displaceable sliding door wing exhibiting:
a drivable spindle with a Z-longitudinal axis;
a spindle nut that can move on the spindle along the Z-longitudinal axis;
an inner ring element that envelops the spindle nut and is connected with the spindle nut by two mutually diametrically opposed stub shafts forming a Y-axis in such a way that the inner ring element can be swivelled around the Y-axis and displaced along the Y- axis;
an outer fork element, which is connected with the inner ring element by two mutually diametrically opposed stub shafts forming an X-axis in such a way that the outer fork element can be swivelled around the X-axis and displaced along the X-axis;

wherein the outer fork element exhibits a support arm for connection with the sliding door/sliding door wing.

The disclosure is based on the underlying idea of keeping disruptive transverse forces and bending moments away from the spindle nut by surrounding it with a structure that prevents component tolerances, exposure to transverse forces and torques, which can cause the spindle nut to become worn or even jammed. One important aspect of the disclosure also lies in the fact that the sliding door drive can also be used for already installed doors. Since the sliding door drive is secured to the sliding door via the support arm, the sliding door drive can be joined to all sliding doors, which are moved by a connecting rod or similar component anyway. No modifications are required in the area of the sliding door wing.

The sliding door drive according to the disclosure is extremely compact, and requires negligibly more installation space around the spindle than the spindle nut according to prior art. The free space around the spindle is most often generously proportioned in prior art anyway, so that the relatively slight circumferential enlargement around the spindle nut can be tolerated.

In addition, the installation space can also be reduced according to the disclosure by adjusting the degrees of freedom or possible movements to expected component tolerances or transverse forces, for example, only permitting a small displacement path along the Y-axis or X-axis.

According to the disclosure, the four stub shafts are each mounted via a slide bearing connection, which realizes a displacement along the Y-axis or X-axis. However, it is alternatively also possible, for example, to enable a displacement along the X-axis through the displaceable mounting of the support arm. It is only important that the spindle nut be largely prevented from moving in the X-direction.

In an especially advantageous embodiment, it is also possible to flexibly mount the four stub shafts, and thereby ensure the necessary degrees of freedom in terms of movement.

### BRIEF DESCRIPTION OF THE FIGURES

The disclosure will be explained in greater detail below based on the attached figures. These must be viewed only as examples, and are not intended to limit the disclosure to the depicted embodiments. Shown on:

FIG. 1: is a perspective view of the sliding door drive according to the disclosure;

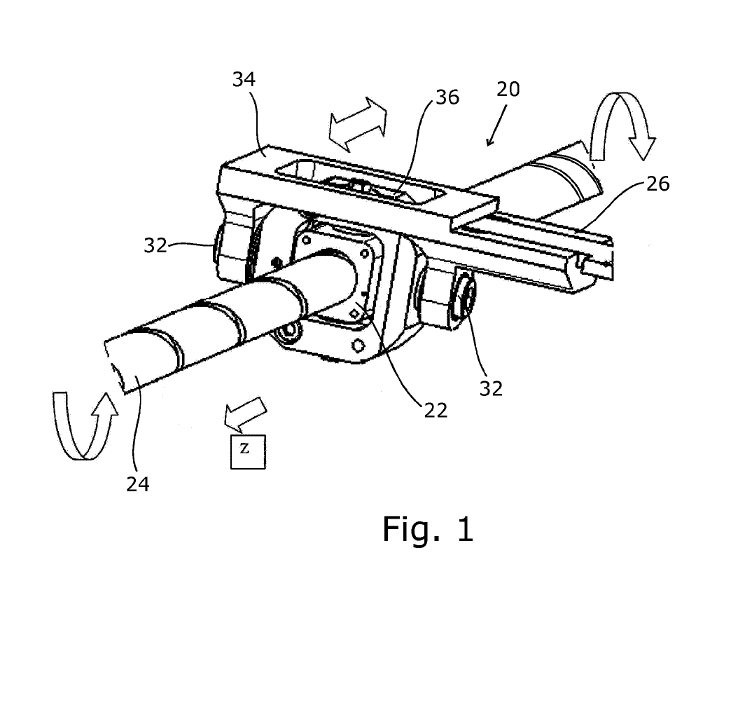

FIG. 2: is a cross sectional view of the sliding door drive according to FIG. 1.

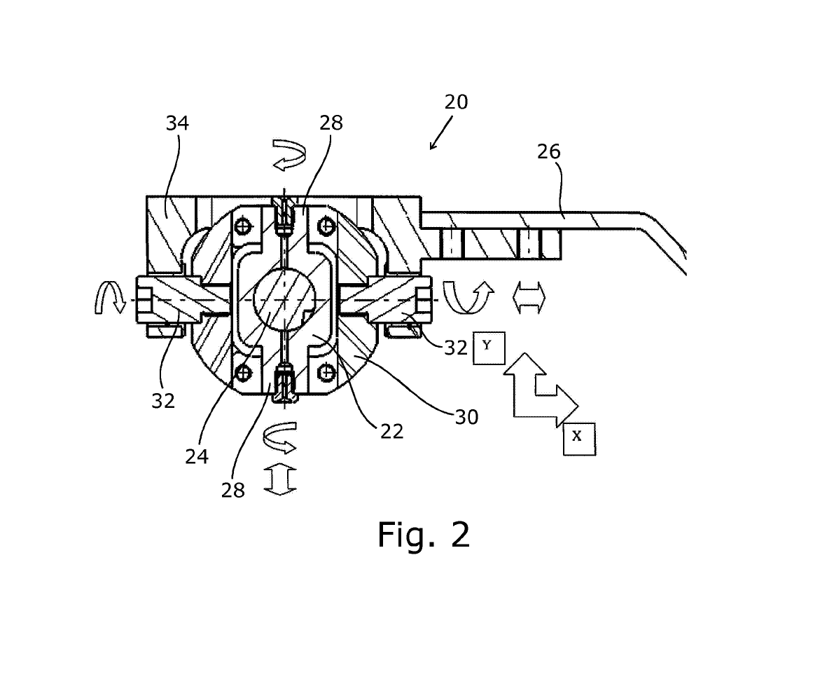

### DETAILED DESCRIPTION

The two figures depict a sliding door drive 20 according to the disclosure, which is arranged so that it can longitudinally move on a driven spindle 24 by way of a spindle nut 22. The spindle 24 is usually electrically driven, and converts the rotational motion into a linear motion via the spindle nut 22. A support arm 26 is joined with a sliding door wing (not shown), and uses the linear motion of the spindle nut 22 to open or close a sliding door. The spindle 24 exhibits a Z-longitudinal axis.

The spindle nut 22 is pivoted to an inner ring element 30 via two first stub shafts 28. A slide bearing connection allows a swivelling motion around the Y-axis, and a linear motion along the Y-axis. The two first stub shafts 28 are arranged diametrically opposite each other, and form a Y-axis that runs through the first two stub shafts 28.

The inner ring element 30 is in turn pivoted by two second stub shafts 32 with an outer fork element 34, which in the exemplary embodiment shown is joined with the support arm 26. The second stub shafts 32 are arranged diametrically opposite each other, and form an X-axis. The connection between the inner ring element 30 and driving fork 34, i.e., the mounting of the second stub shaft 32, is also configured as a slide bearing connection, and allows a swivelling motion around the X-axis and a linear motion along the X-axis.

In the exemplary embodiment shown, the fork element 34 exhibits an opening 36, through which the adjacent first stub shaft 28 can be reached or mounted.

According to the disclosure, the support arm 26 is advantageously provided as a replacement component, thereby enabling an on-site adjustment to prescribed conditions and geometries. For example, if the sliding door drive according to the disclosure is being retrofitted, a corresponding support arm 26 with suitable dimensions can be selected, and secured to the fork element 34.

The disclosure is not limited to the exemplary embodiments shown, but is rather intended to also encompass equivalent configuration variants. In particular, it is possible to kinematically reverse how the different components of the sliding door drive are mounted. What is important is that the motions keeping the spindle nut clear of undesired loads and torques be enabled. It is advantageous for the sliding door drive 20 according to the disclosure or its components to be made out of a robust material. These can include in particular metals, preferably steel, but also resistant plastics.

1. A sliding door drive for a displaceable sliding door, which exhibits:
a drivable spindle with a Z-longitudinal axis;
a spindle nut that can move on the spindle along the Z-longitudinal axis;
an inner ring element that envelops the spindle nut and is connected with the spindle nut by two mutually diametrically opposed stub shafts forming a Y-axis in such a way that the inner ring element can be swivelled around the Y-axis and displaced along the Y-axis;
an outer fork element, which is connected with the inner ring element by two mutually diametrically opposed stub shafts forming an X-axis in such a way that the outer fork element can be swivelled around the X-axis and displaced along the X-axis;
wherein the outer fork element exhibits a support arm for connection with the sliding door/sliding door wing.

2. The sliding door drive according to claim 1, wherein the support arm is detachably secured to the fork element.

3. The sliding door drive according to claim 1, wherein the fork element exhibits an opening, through which an adjoining first stub shaft can be accessed.

4. The sliding door drive according to claim 1, wherein the sliding door drive is made out of a plastic.
